(19) United States
(12) Patent Application Publication
(10) Pub. No.: US 2006/0016912 A1
(43) Pub. Date: Jan. 26, 2006

(54) Spray head for sprayers in general and particularly for manual sprayers for sinks and the like

(76) Inventor: Fabrizio Nobili, San Vittore (CH)

Correspondence Address: MODIANO & ASSOCIATI, Via Meravigli, 16, MILAN, 20123, IT

(21) Appl. No.: 11/172,809

(22) Filed: Jul. 5, 2005

(30) Foreign Application Priority Data
Jul. 21, 2004 (IT) MI2004A001472

(51) Int. Cl. B05B 9/01

(52) U.S. Cl. 239/525; 239/583; 239/586

(57) ABSTRACT

A spray head for sprayers in general and for manual sprayers for sinks, comprising an external enclosure that accommodates a water inlet duct that leads into a tip, where a diverter valve is located which can be arranged, by way of positioning elements, in at least one first stable position and one second stable position for two different types of water dispensing, the positioning elements comprising a rocker, which is connected to the diverter valve and can be actuated by a pushbutton that can be activated externally with respect to the tip for transition from the first stable position to the second stable position and for transition from the second stable position to the first stable position.

The present invention relates to a spray head for sprayers in general and particularly for manual sprayers for sinks and the like.

### BACKGROUND OF THE INVENTION

Currently, especially in the field of manual sprayers for sinks and the like, spray heads are already known which allow to change the type of jet that is dispensed.

More specifically, it is possible to have a central or axial dispensing and optionally a sprinkling dispensing by way of one or more rings of holes arranged concentrically on the dispensing portion of the spray head.

For transition from one type of dispensing to another and/or vice versa, the background art provides a pushbutton, which is located in the rear part of the tip of the spray head and is actuated in order to shift the jet from the central position to the external position with sprinkling dispensing, whereas to perform the opposite change, i.e., transition from sprinkling dispensing to central dispensing, it is necessary to use a lever that is rotated.

This kind of solution has proved to be very complex from a structural standpoint and moreover is not welcomed by the user, since it does not allow for very practical actuation because it is necessary to perform two different types of actuations to change the type of water dispensing.

### SUMMARY OF THE INVENTION

The aim of the invention is to solve the problem described above by providing a spray head for sprayers in general, particularly for manual sprayers for sinks and the like, that allows to perform the transition from one type of dispensing to the other by always using the same actuation element.

Within this aim, an object of the invention is to provide a spray head that allows to provide actuation rapidly and with a structure that is very compact and simple to provide.

Another object of the present invention is to provide a spray head that thanks to its particular constructive characteristics is capable of giving the greatest assurances of reliability and safety in use.

Another object of the present invention is to provide a spray head for sprayers in general and particularly for manual sprayers for sinks and the like that can be easily obtained starting from commonly commercially available elements and materials and is further competitive from a merely economical standpoint.

This aim and these and other objects that will become better apparent hereinafter are achieved by a spray head for sprayers in general and particularly for manual sprayers for sinks and the like, which comprises an external enclosure that accommodates a water inlet duct that leads into a tip, where a diverter valve is located, said diverter valve being arrangeable, by way of positioning means, in at least one first stable position and one second stable position for two different types of water dispensing, characterized in that said positioning means comprise a rocker, which is connected to said diverter valve and can be actuated by means of a pushbutton that can be activated externally with respect to said tip for transition from said first stable position to said second stable position and for transition from said second stable position to said first stable position.

### BRIEF DESCRIPTION OF THE DRAWINGS

Further characteristics and advantages of the invention will become better apparent from the description of a preferred but not exclusive embodiment of a spray head for sprayers in general and particularly for manual sprayers for sinks and the like, illustrated by way of non-limiting example in the accompanying drawings, wherein:

FIG. 1 is a schematic sectional perspective view of the spray head according to the invention;

FIG. 2 is an exploded view of the spray head;

FIG. 3 is a sectional view of a detail of the tip of the spray head;

FIG. 4 is a sectional view of the detail of the tip of the spray head, illustrating the means for connection to the rocker;

FIG. 5 is a partially cutout view of the spray head, illustrating the positioning means;

FIG. 6 is a schematic view of the step of actuating the pushbutton for passing from the first position to the second position;

FIG. 7 is a view of the arrangement of the rocker in the inactive condition and with the valve in the first position;

FIG. 8 is a schematic view of the step for transition from the second position to the first position;

FIG. 9 is a view of the detail of the positioning means with the valve in the second position.

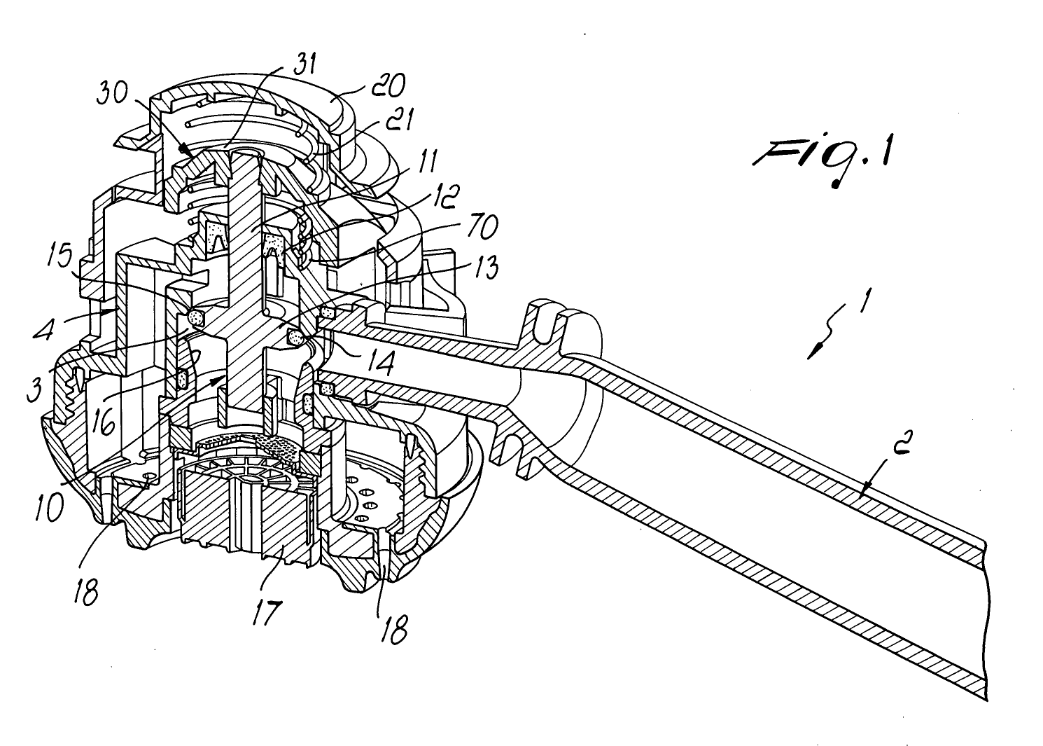

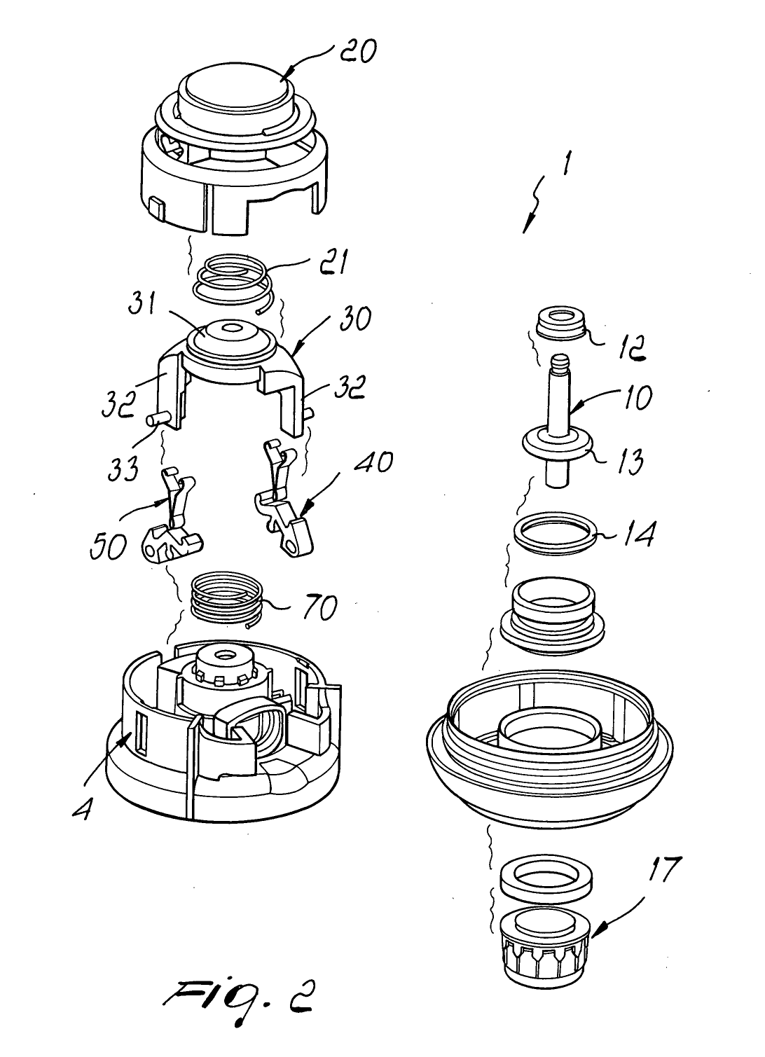

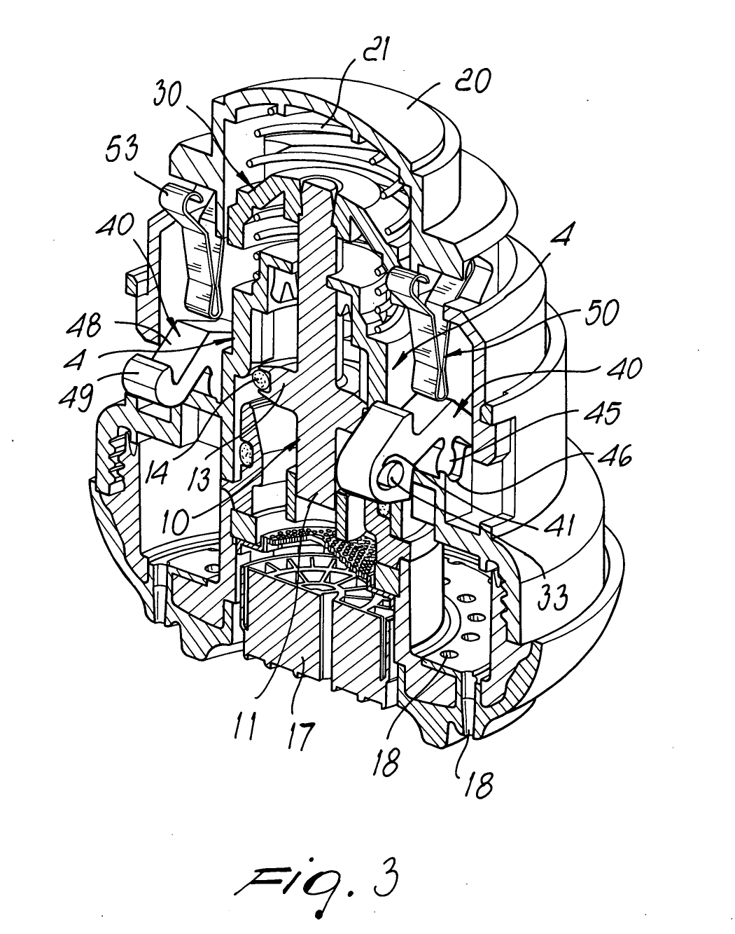

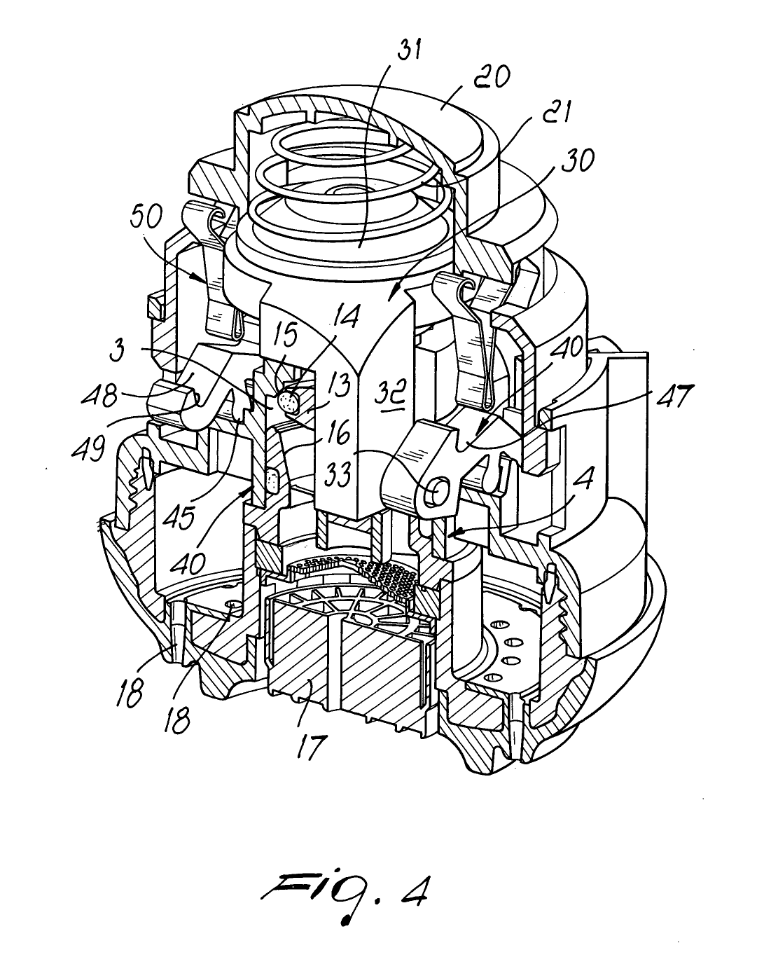

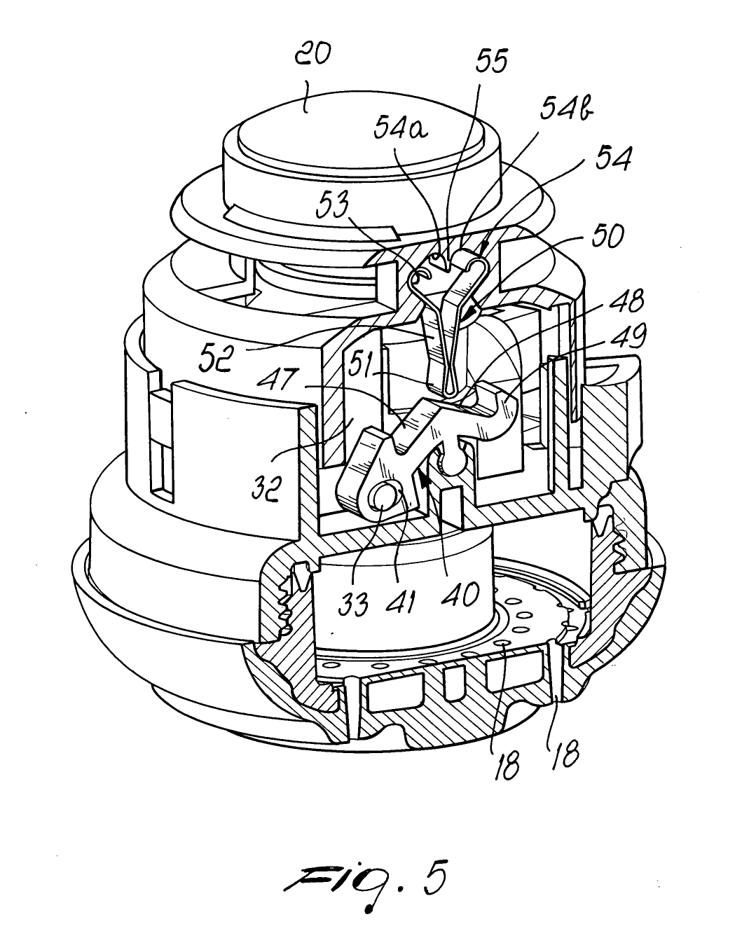

### DESCRIPTION OF THE PREFERRED EMBODIMENTS

With reference to the figures, the spray head for sprayers in general and particularly for manual sprayers for sinks and the like, according to the invention, generally designated by the reference numeral 1, comprises a handle body inside which there is a water inlet duct 2, which runs inside the handle and leads into a distribution chamber 3, formed inside a tip 4, which is covered externally by the conventional bulb.

The tip 4 is provided with a diverter valve, which is generally designated by the reference numeral 10 and is provided with a stem 11 that runs axially inside the tip and protrudes hermetically due to the presence of a lip gasket 12.

On the stem, inside the chamber 3, there is a diverter piston 13, which supports an annular gasket 14 that acts on a first abutment seat 15 and on a second abutment seat 16, so as to be able to define two stable positions, i.e., a first stable position and a second stable position for two different types of water dispensing.

In greater detail, when the diverter valve is in the first position, the annular gasket 14 abuts against the first seat 15 and the water that enters the distribution chamber 3 is conveyed axially through a jet breaker, designated by the reference numeral 17.

By means of the stem 11, as clarified hereinafter, the diverter valve can be positioned so that the annular gasket 14 forms a seal on the second abutment seat 16, and in this case the water is conveyed to a plurality of holes 18, which are arranged circumferentially so as to form sprinkler-type jets.

The peculiarity of the invention consists in that in order to transfer the valve 10 from the first position to the second position and from the second position to the first position, a pushbutton 20 is used which can be accessed externally with respect to the tip 4 at its upper part.

The pushbutton can slide under the action of, and in contrast with, a pushbutton spring 21, which acts between the internal part of the pushbutton and the top surface 31 of an actuator, generally designated by the reference numeral 30, which is connected to the upper end of the stem 11, externally with respect to the chamber 3.

The actuator 30 is provided with opposite arms 32, which run axially with respect to the distribution chamber 3 and are substantially parallel to the extension of the stem 11.

The actuator 30 is a part of means for positioning the diverter valve, which comprise two rockers 40, which are diametrically opposite; each rocker is fitted so that it can oscillate, on the external portion of the chamber 3, and forms an elongated slot 41 for engagement with connection pins 33 provided at the ends of the arms 32.

The rocker 40 is provided with a fulcrum 45, which is mounted so that it can oscillate in a seat 46 of the rocker 40 formed on the external portion of the tip 4.

The rocker is provided, in an upward region, with a first ramp 47, which is inclined toward the end for connection to the pin 33, and a second ramp 48, which is inclined on the opposite side up to a retention portion 49 formed at the end of the second ramp.

To actuate the rocker 40, there is an actuation strut, generally designated by the reference numeral 50, which is provided substantially by means of a Y-shaped lamina, which is provided with an actuation end 51 provided at the central stem, from which branches 52 protrude which end with a respective curled diverging portion 53 and are accommodated in a seat 54 for the oscillating accommodation of the strut 50.

The seat 54 is provided with curved portions 54a and 54b, which are separated one another by means of a central partition 55 and allow the free oscillation of the diverging portions 53, so as to allow the oscillation of the actuation strut as a function of the portion of ramp with which it engages.

The spray head further comprises a return spring 70 for the diverter valve, which acts between the lower face of the top surface 31 and the upper part of the tip 4 and is meant to set a first stable position for the diverter valve, always returning the diverter valve to such position.

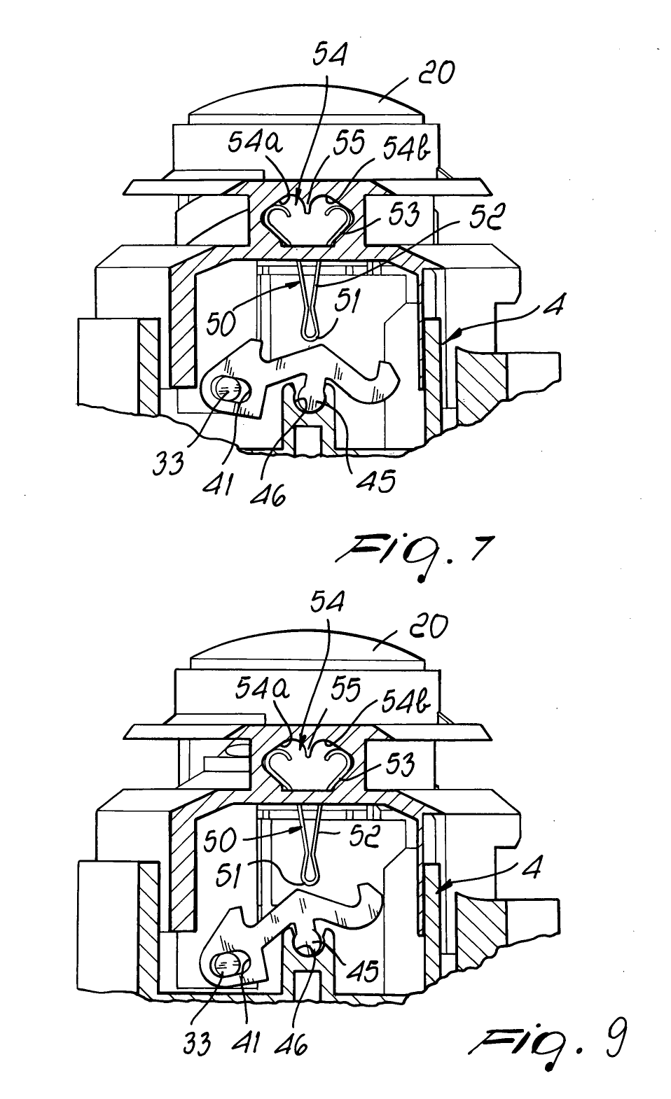

With the diverter valve 10 in the first stable position, in which the diverter piston 13 is in contact with the first seat 15, the rocker 46 is in the position shown in FIG. 7, and therefore the incoming water jet is directed toward the jet breaker 17.

By acting on the pushbutton 20, the actuation strut 50 is made to perform a translational motion, and its lower actuation end 51 is arranged at the first ramp 47 of the rocker 40.

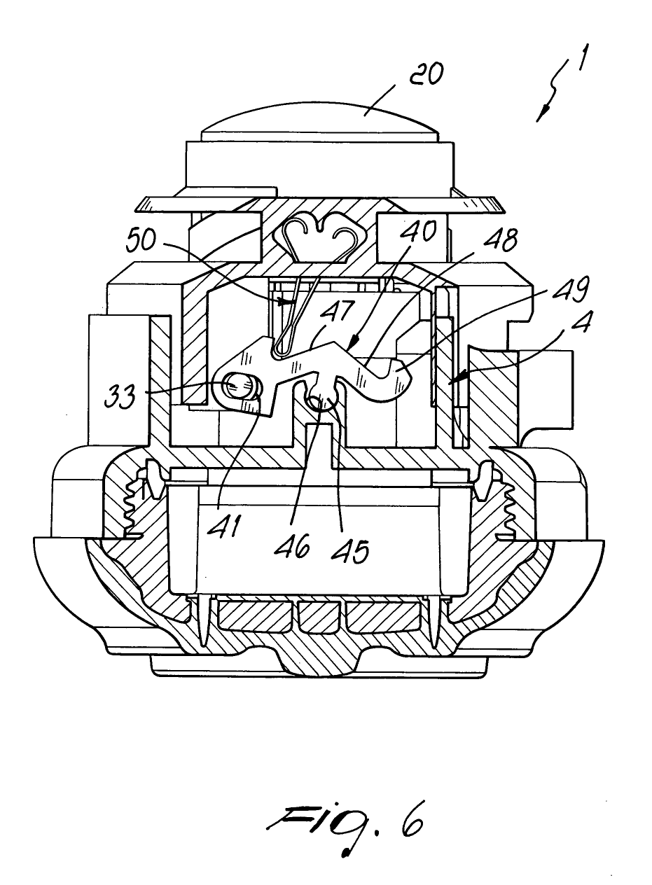

As the descent of the pushbutton 20 continues, the strut 50 is arranged as shown in FIG. 6 and the oscillation of the rocker 40 begins, causing at the same time the descent of the actuator 30 and accordingly the descent of the valve 10, the flow control piston whereof reaches the second position, forming a seal on the second seat 16.

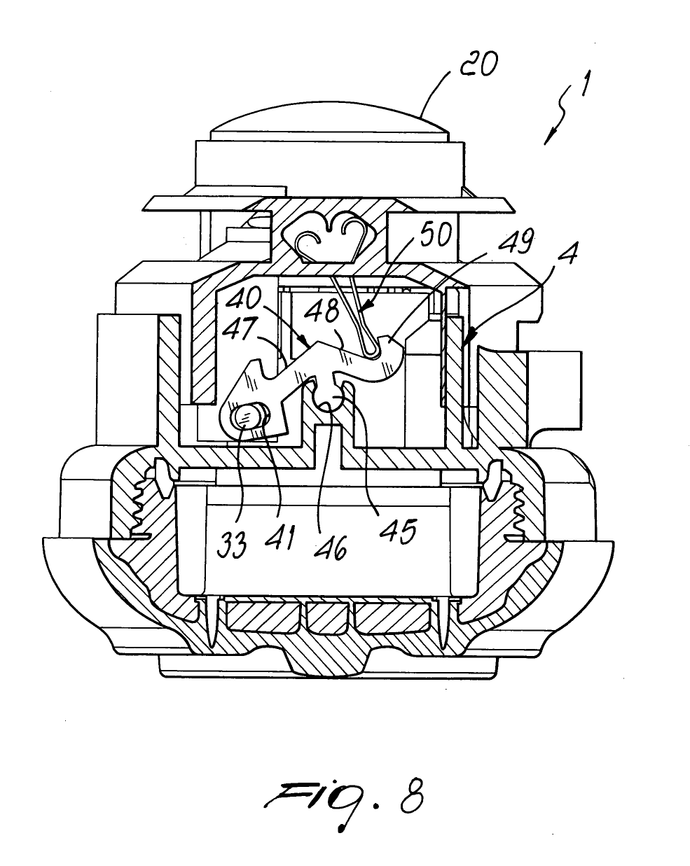

The rocker is thus positioned as shown in FIG. 8.

As long as the dispensing of water continues, the pressure applied by the water keeps the valve 10 in the second position, and therefore, if the user wishes to change the jet again, he can act again on the pushbutton 20, and in this case the strut 50 engages, with its end 51, the second ramp 48 of the rocker 40, which by being made to oscillate about its own fulcrum 45 has the other ramp portion arranged below the rocker 40, so that the pushbutton, in its descent, causes the oscillation of the rocker 40 in the opposite direction and consequently causes the transition from the second position to the first position.

If the user interrupts the dispensing of water, the return spring 70 of the valve returns the piston 13 to the first position and at the same time causes the oscillation in the opposite direction of the rocker 40, so that it is arranged in the first position, shown in FIG. 7, and is arranged so that when the pushbutton 20 is actuated the valve 10 can be transferred to the second position.

From what has been described above, it is thus evident that the invention achieves the intended aim and objects, and in particular the fact is stressed that the actuation means provide a rocker which is made to oscillate at each movement of the valve, so that the rocker is always in a position that corresponds to the position of the valve and therefore the actuation of the pushbutton always causes transition to the other position.

The invention thus conceived is susceptible of numerous modifications and variations, all of which are within the scope of the appended claims.

All the details may further be replaced with other technically equivalent elements.

In practice, the materials used, as well as the contingent shapes and dimensions, may be any according to requirements.

The disclosures in Italian Patent Application No. MI2004A001472 from which this application claims priority are incorporated herein by reference.

What is claimed is:

1. A spray head for sprayers in general and particularly for manual sprayers for sinks, comprising an external enclosure that accommodates a water inlet duct that leads into a tip, where a diverter valve is located, said diverter valve being arrangeable, by way of positioning means, in at least one first stable position and one second stable position for two different types of water dispensing, wherein said positioning means comprise at least one rocker, which is connected to said diverter valve and can be actuated by means of a pushbutton that can be activated externally with respect to said tip for transition from said first stable position to said second stable position and for transition from said second stable position to said first stable position.

2. The spray head according to claim 1, wherein said positioning means comprise an actuator, which is connected to an upper end of a stem that supports a diverter piston with an annular gasket and provides said diverter valve.

3. The spray head according to claim 2, further comprising a pushbutton spring that acts between an internal part of said pushbutton and a top surface of said actuator.

4. The spray head according to claim 3, wherein said actuator comprises opposite arms that protrude axially with respect to a distribution chamber in which said diverter piston slides.

5. The spray head according to claim 4, further comprising two opposite rockers, each rocker being mounted so that it can oscillate and having, at one of its ends, an elongated slot that can engage a connecting pin formed at an end of each one of said arms.

6. The spray head according to claim 5, wherein said rocker is provided with a fulcrum that is mounted so that it can oscillate in a rocker seat formed on an external portion of said tip.

7. The spray head according to claim 6, wherein said rocker has, on an opposite side with respect to said fulcrum, a first ramp that is inclined towards an end for connection to said connecting pin and a second ramp that is inclined on an opposite side up to a retention portion that is formed at the end of said rocker.

8. The spray head according to claim 7, further comprising a strut for actuating said rocker, which is functionally connected to said pushbutton.

9. The spray head according to claim 8, wherein said actuation strut comprises a Y-shaped lamina, which forms an actuation end located at a central stem, from which branches protrude which end with diverging portions that can be accommodated in a seat for oscillating accommodation of the actuation strut, said seat being formed in said pushbutton.

10. The spray head according to claim 9, wherein said seat is provided with curved portions that are separated one another by means of a central partition and allow free oscillation of said diverging portions.

11. The spray head according to claim 3, further comprising a spring for the return of the diverter valve that acts between a lower face of said top surface of the actuator and the upper part of said tip.

12. The spray head according to claim 8, wherein the oscillation of said rocker changes the one of said ramps that is arranged at said actuation end of said Y-shaped lamina.
